(19) United States
(12) Patent Application Publication
(10) Pub. No.: US 2026/0102832 A1
(43) Pub. Date: Apr. 16, 2026

(54) WELD SEAM STRUCTURE AND WELDING PROCESS SUITABLE FOR A NARROW-GAP WATER-COOLED WALL TUBE PANEL

(71) Applicant: HUANENG POWER INTERNATIONAL, INC. SHANG'AN POWER PLANT, SHIJIAZHUANG (CN)

(72) Inventors: HUALONG WANG, SHIJIAZHUANG (CN); GUANGCHEN ZHANG, SHIJIAZHUANG (CN); ZHIBIN MIAO, SHIJIAZHUANG (CN); SHENGBO FENG, SHIJIAZHUANG (CN); DONG LI, SHIJIAZHUANG (CN); SHIDA LIU, SHIJIAZHUANG (CN); YUCHAN SHAN, SHIJIAZHUANG (CN)

(73) Assignee: HUANENG POWER INTERNATIONAL, INC. SHANG'AN POWER PLANT, SHIJIAZHUANG (CN)

(21) Appl. No.: 19/344,582

(22) Filed: Sep. 30, 2025

Related U.S. Application Data
(63) Continuation of application No. PCT/CN2024/125204, filed on Oct. 16, 2024.

(51) Int. Cl. B23K 9/00; B23K 31/02; B23K 31/12; B23K 37/02

(52) U.S. Cl. CPC B23K 9/0052; B23K 31/02; B23K 31/125; B23K 37/0211

(57) ABSTRACT

Provided are a weld seam structure and a welding process suitable for a narrow-gap water-cooled wall tube panel. The weld seam structure comprises a groove-type gap formed between adjacent water-cooled wall tubes, where welding joints are arranged on sides of the adjacent water-cooled wall tubes that are close to each other, and the welding joints are distributed on an upper side of the groove-type gap, and the welding joints communicate with the groove-type gap. In addition to the original welding joints, the adjacent water-cooled wall tubes are considered as a whole; and the gap between the water-cooled wall tubes is processed into a groove type and welded together with the welding joints, which increases the thickness of the weld seam at the tangent point and the safety factor, also facilitates performing radiographic non-destructive testing.

### CROSS-REFERENCE TO RELATED APPLICATIONS

This application is a continuation of PCT/CN2024/125204, filed on Oct. 16, 2024 claims priority to Chinese Patent Application No. 202410855805.8, filed on Jun. 28, 2024, the contents of which are hereby incorporated by reference.

### TECHNICAL FIELD

The present disclosure relates to the field of boiler manufacturing technologies, and in particular, to a weld seam structure and a welding process suitable for a narrow-gap water-cooled wall tube panel.

### BACKGROUND

A water-cooled wall is a main heat-receiving component of a power station boiler and is distributed around a boiler furnace. Its interior is flowing water or steam, and its exterior receives heat of the flame radiation of the boiler furnace. Membrane-type water-cooled walls are generally used in modern large-capacity boilers. According to difference in the wall thickness of water-cooled wall tubes, V-type or U-type grooves are generally adopted for on-site assembly and welding of water-cooled walls. However, when the gap between adjacent water-cooled wall tubes is smaller, since it is inconvenient for observation, welding operation, and non-destructive testing, the welding quality at a position of the tangent point of the adjacent water-cooled wall tubes cannot be effectively guaranteed, thereby posing a significant potential hazard to the safe operation of a unit.

### SUMMARY

The present disclosure provides a weld seam structure and a welding process suitable for a narrow-gap water-cooled wall tube panel to solve the technical problem that when the gap between adjacent water-cooled wall tubes is smaller, since it is inconvenient for observation, welding operation, and non-destructive testing, the welding quality at the position of the tangent point of the adjacent water-cooled wall tubes cannot be effectively guaranteed, thereby posing a significant potential hazard to the safe operation of a unit.

To solve the above technical problem, the present disclosure discloses a weld seam structure suitable for a narrow-gap water-cooled wall tube panel, including a groove-type gap formed between adjacent water-cooled wall tubes, where welding joints are arranged on sides of the adjacent water-cooled wall tubes that are close to each other, and the welding joints are distributed on an upper side of the groove-type gap, and the welding joints communicate with the groove-type gap.

Preferably, the groove-type gap includes any one of a V-type groove and a U-type groove.

A welding process for welding a weld seam structure suitable for a narrow-gap water-cooled wall tube panel includes the following steps:
Step 1: processing water-cooled wall tubes to form welding joints, processing a gap between adjacent water-cooled wall tubes to make it form a groove-type gap, and then polishing surfaces of the water-cooled wall tubes until metallic luster is exposed;
Step 2: baking a welding electrode to a target temperature, and then placing the welding electrode in an electrode heat-insulating barrel for use;
Step 3: preheating the water-cooled wall tubes to make all parts of materials to be welded heated uniformly;
Step 4: placing the water-cooled wall tubes on a welding device, such that the groove-type gap is formed between the adjacent water-cooled wall tubes, and then welding the water-cooled wall tubes;
Step 5: heating weld seams and heat-affected zones of the water-cooled wall tubes with a heating torch to achieve the purpose of hydrogen removal; and
Step 6: performing non-destructive testing on the weld seams after the hydrogen removal is completed.

Preferably, in the Step 2, a baking temperature of the welding electrode is 300-500° C., and a baking duration of the welding electrode is 0.5-3 hours.

Preferably, in the Step 4, when welding the water-cooled wall tubes, a welding current is 300-320 A, a welding voltage is 22-27 V, and a welding speed is 80-90 mm/min.

Preferably, in the Step 5, when heating the weld seams and heat-affected zones of the water-cooled wall tubes, a layer of asbestos is laid on the ground, and the welded water-cooled wall tubes are placed on the asbestos; and whenever they are heated to a certain length, they are covered with asbestos.

Preferably, the welding device includes a base plate, where a cavity is arranged in a middle part of the base plate, a number of first support bases are arranged at uniform intervals in the cavity along a front-rear direction, a first support groove is arranged at an upper end of each first support base, a number of telescopic rods are arranged at uniform intervals along the front-rear direction on a left side of an upper end of the base plate, the number of telescopic rods and the number of first support bases are arranged in one-to-one correspondence, each telescopic rod is fixedly connected with a connecting block, the connecting block is slidably connected with a second support base, a second support groove is arranged at a lower end of the second support base, the second support groove correspondingly communicates with the first support groove, an upper end of the second support base is connected with a fixed block, a spring is fixedly arranged between the fixed block and the connecting block, a number of sliding blocks and a number of positioning holes are arranged at uniform intervals along the front-rear direction on a right side of the upper end of the base plate, each sliding block is slidably connected with the fixed block along an up-down vertical direction, the sliding block and the telescopic rod are slidably connected along the front-rear direction of the base plate, a fixed shaft is fixedly arranged in the sliding block, one end of the fixed shaft is rotatably connected with the first support base, a threaded hole is arranged on a side of the fixed shaft away from the first support base, the threaded hole is threadedly connected with a threaded rod, and the threaded rod is correspondingly matched with the positioning hole.

Preferably, mounting mechanisms are symmetrically arranged on the left and right sides of the upper and lower ends of the base plate, where each mounting mechanism includes a number of mounting blocks, the number of mounting blocks are arranged at uniform intervals on the base plate along the front-rear direction, a driving threaded rod is rotatably arranged between the mounting blocks on the left and right sides, a threaded section of the driving threaded rod is threadedly connected with a movable block, a cylindrical section of the driving threaded rod penetrates through the mounting block on the left side and is fixedly connected with a driving motor, the driving motor is fixedly connected with the mounting block, a working cavity is arranged inside the movable block, a sliding plate is slidably arranged in the working cavity, the sliding plate is fixedly connected with an electric telescopic rod and an automatic welding head, the electric telescopic rod is fixedly arranged in the working cavity, the automatic welding head is slidably connected with the movable block, and the automatic welding head is connected with the welding electrode.

Preferably, there is further included a method for controlling a preheating temperature of a water-cooled wall tube, including the following steps:
Step 7: calculating a target preheating temperature of the water-cooled wall tube according to Formula (1);

$$T = \vert \frac{3 * K * E * c}{π * L * {e}^{\frac{3 {H}^{2}}{{L}^{2}}} * J} - \frac{Z}{C * m} \vert ; \qquad ( 1 )$$

where T is the target preheating temperature of the water-cooled wall tube, K is welding thermal efficiency of an automatic welding head during operation, E is a welding voltage of the automatic welding head during operation, c is an arc current of the automatic welding head during operation, L is a width of a groove-type gap, e is the natural constant, H is a distance between the automatic welding head and the groove-type gap, J is a thermal conductivity coefficient of the water-cooled wall tube, Z is a maximum allowable deformation of the water-cooled wall tube, C is a linear expansion coefficient of the water-cooled wall tube, and m is a thickness of the water-cooled wall tube; and
Step 8: detecting temperature of the water-cooled wall tube by a temperature detector, and upon the temperature of the water-cooled wall tube detected by the temperature detector reaches the target preheating temperature, stopping preheating the water-cooled wall tube and starting welding the water-cooled wall tube.

The technical solutions of the present disclosure are further described in detail below with reference to the accompanying drawings and embodiments.

Compared with the prior art, the present disclosure has the following beneficial effects:

In addition to the original welding joints, the adjacent water-cooled wall tubes are considered as a whole; and the gap between the water-cooled wall tubes is processed into a groove type and welded together with the welding joints, which increases the thickness of the weld seam at the tangent point and the safety factor, and also facilitates performing radiographic non-destructive testing.

### BRIEF DESCRIPTION OF THE DRAWINGS

The accompanying drawings are used to provide a further understanding of the present disclosure and constitute a part of the specification. They are used to explain the present disclosure together with the embodiments of the present disclosure, and do not limit the present disclosure. In the accompanying drawings:

FIG. 1 is a structural schematic diagram of the present disclosure;

FIG. 2 is a structural schematic diagram of a sliding block of the present disclosure;

FIG. 3 is an enlarged structural schematic diagram of Area A in FIG. 1; and

FIG. 4 is a structural schematic diagram of a movable block of the present disclosure.

In the figures: 1. Base plate; 2. Mounting block; 3. Driving threaded rod; 4. Driving motor; 5. Movable block; 6. Automatic welding head; 7. Working cavity; 8. Electric telescopic rod; 9. Sliding plate; 10. Telescopic rod; 11. Connecting block; 12. Spring; 13. Fixed block; 14. First support base; 15. First support groove 1; 16. Water-cooled wall tube; 17. Second support base; 18. Second support groove; 19. Sliding block; 20. Fixed shaft; 21. Positioning hole; 22. Cavity; 23. Threaded hole; 24. Threaded rod.

### DETAILED DESCRIPTION OF THE EMBODIMENTS

The preferred embodiments of the present disclosure will be described below in conjunction with the accompanying drawings. It should be understood that the preferred embodiments described herein are only used to describe and explain the present disclosure, and are not used to limit the present disclosure.

In addition, in the present disclosure, descriptions involving terms such as “first” and “second” are for descriptive purposes only, and are not intended to specifically indicate an order or sequence, nor to limit the present disclosure. They are merely used to distinguish components or operations described by the same technical terms, and shall not be construed as indicating or implying their relative importance or implicitly specifying the number of the indicated technical features. Therefore, a feature defined with “first” or “second” may explicitly or implicitly include at least one such feature. In addition, the technical solutions and technical features between the various embodiments may be combined with each other, but such combination must be based on the realization by those of ordinary skill in the art. When the combination of technical solutions is contradictory or cannot be realized, such combination of technical solutions shall be deemed to not exist, and shall not fall within the scope of protection claimed by the present disclosure.

The present disclosure provides the following embodiments:

### Embodiment 1

The embodiment of the present disclosure provides a weld seam structure suitable for a narrow-gap water-cooled wall tube panel, which includes a groove-type gap formed between adjacent water-cooled wall tubes 16, where welding joints are arranged on sides of the adjacent water-cooled wall tubes 16 that are close to each other, and the welding joints are distributed on an upper side of the groove-type gap, and the welding joints communicate with the groove-type gap.

The groove-type gap includes any one of a V-type groove and a U-type groove.

The beneficial effects of the above technical solution are as follows:

In addition to the original welding joints, the adjacent water-cooled wall tubes 16 are considered as a whole; and the gap between the water-cooled wall tubes 16 is processed into a groove type and welded together with the welding joints, which increases the thickness of the weld seam at the tangent point and the safety factor, also facilitates performing radiographic non-destructive testing, and solves the technical problem that when the gap between adjacent water-cooled wall tubes is smaller, since it is inconvenient for observation, welding operation, and non-destructive testing, the welding quality at the position of the tangent point of the adjacent water-cooled wall tubes cannot be effectively guaranteed, thereby posing a significant potential hazard to the safe operation of a unit.

### Embodiment 2

On the basis of Embodiment 1, a welding process for welding a weld seam structure suitable for a narrow-gap water-cooled wall tube panel includes the following steps:
Step 1: processing water-cooled wall tubes 16 to form welding joints, processing a gap between adjacent water-cooled wall tubes 16 to make it form a groove-type gap, and then polishing surfaces of the water-cooled wall tubes 16 until metallic luster is exposed;
Step 2: baking a welding electrode to a target temperature, and then placing the welding electrode in an electrode heat-insulating barrel for use;
Step 3: preheating the water-cooled wall tubes 16 to make all parts of materials to be welded heated uniformly;
Step 4: placing the water-cooled wall tubes 16 on a welding device, such that the groove-type gap is formed between the adjacent water-cooled wall tubes 16, and then welding the water-cooled wall tubes 16;
Step 5: heating weld seams and heat-affected zones of the water-cooled wall tubes 16 with a heating torch to achieve the purpose of hydrogen removal;
Step 6: performing non-destructive testing on the weld seams after the hydrogen removal is completed;

In the Step 2, a baking temperature of the welding electrode is 300-500° C., and a baking duration of the welding electrode is 0.5-3 hours;

In the Step 4, when welding the water-cooled wall tubes 16, a welding current is 300-320 A, a welding voltage is 22-27 V, and a welding speed is 80-90 mm/min; and

In the Step 5, when heating the weld seams and heat-affected zones of the water-cooled wall tubes 16, a layer of asbestos is laid on the ground, and the welded water-cooled wall tubes 16 are placed on the asbestos; and whenever they are heated to a certain length, they are covered with asbestos.

The beneficial effects of the above technical solution are as follows:

Before welding, the water-cooled wall tubes 16 shall be preheated, so that all parts of the water-cooled wall tubes 16 are heated uniformly; and after welding, they shall be immediately covered with heat insulation cotton to avoid crack formation due to rapid cooling of the welded water-cooled wall tubes 16; hydrogen removal is performed after welding: the weld seams and heat-affected zones are heated with a heating torch, and one section shall be immediately covered with asbestos after being heated; then testing is conducted; if unqualified, repair welding is required; the entire processing process ensures that no cracks appear at the weld seams; if a product is unqualified in testing, the repair-welded site needs to be preheated to above 200° C. before welding, and manual tungsten inert gas welding is adopted for repair welding with the welding wire being TIG-R31; immediately after repair welding, the repair-welded site is wrapped with asbestos to allow slow cooling; and after the repair welding is completed, non-destructive testing is performed again on the repair-welded site.

### Embodiment 3

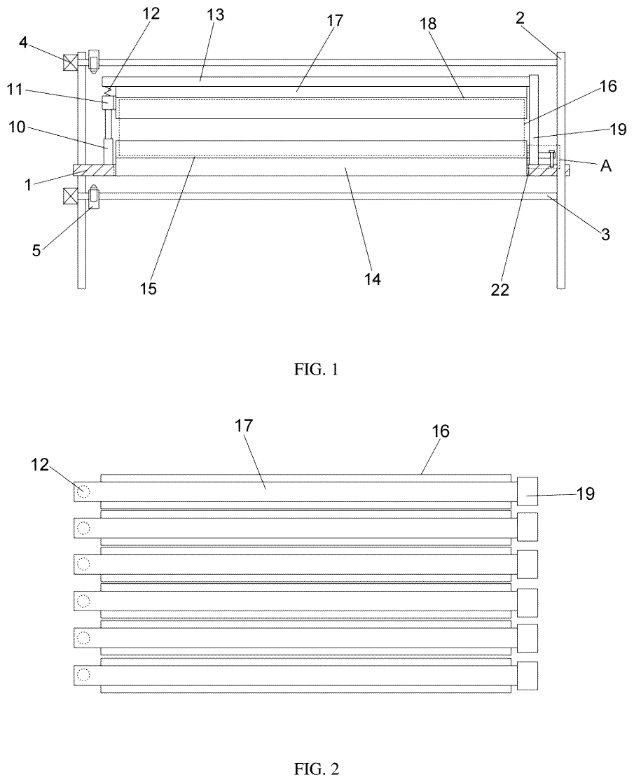

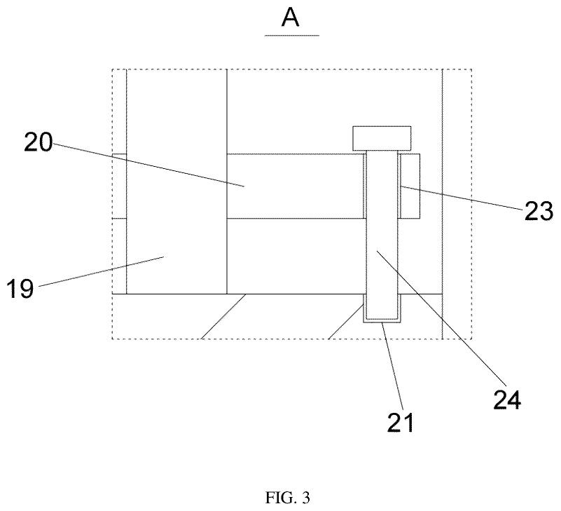

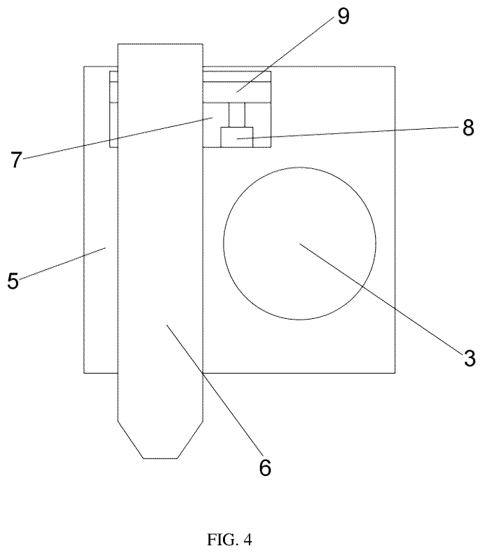

On the basis of Embodiment 2, as shown in FIGS. 1-4, the welding device includes a base plate 1. A cavity 22 is arranged in a middle part of the base plate 1. A number of first support bases 14 are arranged at uniform intervals in the cavity 22 along a front-rear direction. A first support groove 15 is arranged at an upper end of each first support base 14. A number of telescopic rods 10 are arranged at uniform intervals along the front-rear direction on a left side of an upper end of the base plate 1. The number of telescopic rods 10 and the number of first support bases 14 are arranged in a one-to-one correspondence. Each telescopic rod 10 is fixedly connected with a connecting block 11. The connecting block 11 is slidably connected with a second support base 17. A second support groove 18 is arranged at a lower end of the second support base 17. The second support groove 18 correspondingly communicates with the first support groove 15. A fixed block 13 is connected to an upper end of the second support base 17. A spring 12 is fixedly arranged between the fixed block 13 and the connecting block 11. A number of sliding blocks 19 and a number of positioning holes 21 are arranged at uniform intervals along the front-rear direction on a right side of the upper end of the base plate 1. Each sliding block 19 is slidably connected with the fixed block 13 along an up-down vertical direction. The sliding block 19 and the telescopic rod 10 are slidably connected along the front-rear direction of the base plate 1. A fixed shaft 20 is fixedly arranged in the sliding block 19. One end of the fixed shaft 20 is fixedly connected with the first support base 14. A threaded hole 23 is arranged on a side of the fixed shaft 20 away from the first support base 14. The threaded hole 23 is threadedly connected with a threaded rod 24. The threaded rod 24 is correspondingly matched with one positioning hole 21.

Mounting mechanisms are symmetrically arranged on the left and right sides of the upper and lower ends of the base plate 1. Each mounting mechanism includes a number of mounting blocks 2. The number of mounting blocks 2 are arranged at uniform intervals on the base plate 1 along the front-rear direction. A driving threaded rod 3 is rotatably arranged between the mounting blocks 2 on the left and right sides. The driving threaded rod 3 is correspondingly arranged between adjacent sliding blocks 19. A threaded section of the driving threaded rod 3 is threadedly connected with a movable block 5. A cylindrical section of the driving threaded rod 3 penetrates through the mounting block 2 on the left side and is fixedly connected with a driving motor 4. The driving motor 4 is fixedly connected with the mounting block 2. A working cavity 7 is arranged inside the movable block 5. A sliding plate 9 is slidably arranged in the working cavity 7. The sliding plate 9 is fixedly connected with an electric telescopic rod 8 and an automatic welding head 6. The electric telescopic rod 8 is fixedly arranged in the working cavity 7. The automatic welding head 6 is slidably connected with the movable block 5. The automatic welding head 6 is connected with a wire feeder through a wire feeding pipe.

The beneficial effects of the above technical solution are as follows:

To-be-welded water-cooled wall tubes 16 are placed in the first support grooves 15 to support lower ends of the water-cooled wall tubes 16; the telescopic rods 10 are controlled to contract, the telescopic rods 10 drive the connecting blocks 11 to move downward, the connecting blocks 11 drive the fixed blocks 13 to move downward through the springs 12, the fixed blocks 13 drive the second support bases 17 to move downward, and the second support grooves 18 at the lower ends of the second support bases 17 move downward to position upper ends of the water-cooled wall tubes 16; after the second support bases 17 cannot move downward, relative sliding occurs between the second support bases 17 and the sliding blocks 19, the springs 12 are compressed, and under the elastic action of the springs 12, the positioning of the water-cooled wall tubes 16 by the second support bases 17 is more stable; the first support grooves 15 and the second support grooves 18 are of semi-circular structures, and the diameters of the first support grooves 15 and the second support grooves 18 are smaller than the diameter of the water-cooled wall tubes 16, so as to avoid the first support grooves 15 and the second support grooves 18 shielding the weld joints and groove-type gaps of the water-cooled wall tubes 16; and

After positioning and fixing the water-cooled wall tubes 16, the threaded rods 24 are rotated, so that the threaded rods 24 separate from the positioning holes 21 and the threaded holes 23; and then the fixed shafts 20 are pushed to move forward and backward, the fixed shafts 20 drive the sliding blocks 19 and the first support bases 14 to move forward and backward, and the sliding blocks 19 drive the second support bases 17 to move forward and backward, thereby driving the water-cooled wall tubes 16 to move forward and backward; after the water-cooled wall tubes 16 move to target positions, the threaded rods 24 are tightened with the positioning holes 21 and the threaded holes 23, so that the first support bases 14 and the second support bases 17 no longer move forward and backward, achieving the purpose of adjusting the gap between different water-cooled wall tubes 16, and avoiding the situation that the gap between the water-cooled wall tubes 16 is too small, which is inconvenient for observation, welding operation and testing of the water-cooled wall tubes 16; then the electric telescopic rods 8 are controlled to telescope, the electric telescopic rods 8 drive the automatic welding heads 6 to move toward the water-cooled wall tubes 16, and the wire feeders convey welding wires to the automatic welding heads 6 through the wire feeding pipes until they move to the target positions; then the driving motors 4 are controlled to operate, the driving motors 4 drive the driving threaded rods 3 to rotate, and the driving threaded rods 3 drive the movable blocks 5 to move along a length direction of the water-cooled wall tubes 16 when rotating, completing the automatic welding of the water-cooled wall tubes 16 without manual welding, which is time-saving and labor-saving; the first support bases 14 and the second support bases 17 can be set as thermal insulation materials to reduce the cooling speed of the water-cooled wall tubes 16; the automatic welding heads 6 are arranged up and down and are controlled to operate separately by the driving motors 4 distributed up and down without interfering with each other, and front welding or front and back welding of the water-cooled wall tubes 16 can be performed as required.

### Embodiment 4

On the basis of Embodiment 1, as shown in FIGS. 1-3, there is further included a method for controlling a preheating temperature of a water-cooled wall tube 16, including the following steps:

Step 7: calculating a target preheating temperature of the water-cooled wall tube 16 according to Formula (1);

$$T = \vert \frac{3 * K * E * c}{π * L * {e}^{\frac{3 {H}^{2}}{{L}^{2}}} * J} - \frac{Z}{C * m} \vert ; \qquad ( 1 )$$

where T is the target preheating temperature of the water-cooled wall tube 16, K is welding thermal efficiency of an automatic welding head 6 during operation, E is a welding voltage of the automatic welding head 6 during operation, c is an arc current of the automatic welding head 6 during operation, L is a width of a groove-type gap, e is the natural constant, H is a distance between the automatic welding head 6 and the groove-type gap, J is a thermal conductivity coefficient of the water-cooled wall tube 16, Z is a maximum allowable deformation of the water-cooled wall tube 16, C is a linear expansion coefficient of the water-cooled wall tube 16, and m is a thickness of the water-cooled wall tube 16; and
Step 8: detecting temperature of the water-cooled wall tube 16 by a temperature detector, and upon the temperature of the water-cooled wall tube 16 detected by the temperature detector reaches the target preheating temperature, stopping preheating the water-cooled wall tube 16 and starting welding the water-cooled wall tube 16.

The beneficial effects of the above technical solution are as follows:

The target preheating temperature of the water-cooled wall tube 16 is calculated according to the Formula (1), then the temperature of the water-cooled wall tube 16 is detected by the temperature detector, and upon the temperature of the water-cooled wall tube 16 detected by the temperature detector reaches the target preheating temperature, the preheating of the water-cooled wall tube 16 is stopped and the welding of the water-cooled wall tube 16 is started; and by setting an appropriate preheating temperature, it is avoided that the preheating temperature is lower and the welding temperature is excessively high during welding, resulting in excessively large temperature difference on the water-cooled wall tube 16, so that the deformation at the groove-type gap of the water-cooled wall tube 16 is excessively large, which affects the reliability of the weld structure.

Apparently, those of skill in the art can make various modifications and variations to the present disclosure without departing from the spirit and scope of the present disclosure. In this way, if these modifications and variations of the present disclosure fall within the scope of the claims of the present disclosure and their equivalent technologies, the present disclosure also intends to include these modifications and variations therein.

What is claimed is:

1. A welding process for a narrow-gap water-cooled wall tube panel, comprising the following steps:
Step 1: processing water-cooled wall tubes (16) to form welding joints, processing a gap between adjacent water-cooled wall tubes (16) to make it form a groove-type gap, and then polishing surfaces of the water-cooled wall tubes (16) until metallic luster is exposed;
Step 2: baking a welding electrode to a target temperature, and then placing the welding electrode in an electrode heat-insulating barrel for use;
Step 3: preheating the water-cooled wall tubes (16) to make all parts of materials to be welded heated uniformly;
Step 4: placing the water-cooled wall tubes (16) on a welding device, such that the groove-type gap is formed between the adjacent water-cooled wall tubes (16), and then welding the water-cooled wall tubes (16);
Step 5: heating weld seams and heat-affected zones of the water-cooled wall tubes (16) with a heating torch to achieve the purpose of hydrogen removal; and
Step 6: performing non-destructive testing on the weld seams after the hydrogen removal is completed;
where the welding device comprises:
a base plate (1), where a cavity (22) is arranged in a middle part of the base plate (1), a number of first support bases (14) are arranged at uniform intervals in the cavity (22) along a front-rear direction, a first support groove (15) is arranged at an upper end of each first support base (14), a number of telescopic rods (10) are arranged at uniform intervals along the front-rear direction on a left side of an upper end of the base plate (1), the number of telescopic rods (10) and the number of first support bases (14) are arranged in one-to-one correspondence, each telescopic rod (10) is fixedly connected with a connecting block (11), the connecting block (11) is slidably connected with a second support base (17), a second support groove (18) is arranged at a lower end of the second support base (17), the second support groove (18) correspondingly communicates with the first support groove (15), an upper end of the second support base (17) is connected with a fixed block (13), a spring (12) is fixedly arranged between the fixed block (13) and the connecting block (11), a number of sliding blocks (19) and a number of positioning holes (21) are arranged at uniform intervals along the front-rear direction on a right side of the upper end of the base plate (1), each sliding block (19) is slidably connected with the fixed block (13) along an up-down vertical direction, the sliding block (19) and the telescopic rod (10) are slidably connected along the front-rear direction of the base plate (1), a fixed shaft (20) is fixedly arranged in the sliding block (19), one end of the fixed shaft (20) is rotatably connected with the first support base (14), a threaded hole (23) is arranged on a side of the fixed shaft (20) away from the first support base (14), the threaded hole (23) is threadedly connected with a threaded rod (24), and the threaded rod (24) is correspondingly matched with the positioning hole (21); and
a weld seam structure of the narrow gap water-cooled wall tube panel comprises the groove-type gap formed between the adjacent water-cooled wall tubes (16), wherein the welding joints are arranged on sides of the adjacent water-cooled wall tubes (16) that are close to each other, the welding joints are distributed on an upper side of the groove-type gap, and the welding joints communicate with the groove-type gap.

2. The welding process for a narrow-gap water-cooled wall tube panel according to claim 1, wherein the groove-type gap comprises any one of a V-type groove and a U-type groove.

3. The welding process for a narrow-gap water-cooled wall tube panel according to claim 1, wherein in the Step 2, a baking temperature of the welding electrode is 300-500° C., and a baking duration of the welding electrode is 0.5-3 hours.

4. The welding process for a narrow-gap water-cooled wall tube panel according to claim 1, wherein in the Step 4, when welding the water-cooled wall tubes (16), a welding current is 300-320 A, a welding voltage is 22-27 V, and a welding speed is 80-90 mm/min.

5. The welding process for a narrow-gap water-cooled wall tube panel according to claim 1, wherein in the Step 5, when heating the weld seams and heat-affected zones of the water-cooled wall tubes (16), a layer of asbestos is laid on the ground, and the welded water-cooled wall tubes (16) are placed on the asbestos; and whenever they are heated to a certain length, they are covered with asbestos.

6. The welding process for a narrow-gap water-cooled wall tube panel according to claim 1, wherein
mounting mechanisms are symmetrically arranged on the left and right sides of the upper and lower ends of the base plate (1), wherein each mounting mechanism comprises a number of mounting blocks (2), the number of mounting blocks (2) are arranged at uniform intervals on the base plate (1) along the front-rear direction, a driving threaded rod (3) is rotatably arranged between the mounting blocks (2) on the left and right sides, a threaded section of the driving threaded rod (3) is threadedly connected with a movable block (5), a cylindrical section of the driving threaded rod (3) penetrates through the mounting block (2) on the left side and is fixedly connected with a driving motor (4), the driving motor (4) is fixedly connected with the mounting block (2), a working cavity (7) is arranged inside the movable block (5), a sliding plate (9) is slidably arranged in the working cavity (7), the sliding plate (9) is fixedly connected with an electric telescopic rod (8) and an automatic welding head (6), the electric telescopic rod (8) is fixedly arranged in the working cavity (7), the automatic welding head (6) is slidably connected with the movable block (5), and the automatic welding head (6) is connected with the welding electrode.
